(19) United States
(12) Patent Application Publication
(10) Pub. No.: US 2004/0200325 A1
(43) Pub. Date: Oct. 14, 2004

(54) Extension handle for wrenches

(76) Inventor: Gregory Huffman, Port Colborne (CA)

Correspondence Address: Elias C. Borges, 1 Eva Road, Suite 406, Toronto, ON, M9C 4Z5, CA

(21) Appl. No.: 10/101,457

(22) Filed: Mar. 11, 2002

(30) Foreign Application Priority Data
Mar. 15, 2001 (CA) 2,340,964

(51) Int. Cl. B25B 23/16

(52) U.S. Cl. 81/177.2

(57) ABSTRACT

The extension handle for increasing the leverage of wrenches of the present invention comprises an elongated member having a side, a length and opposite first and second ends, the first end being adapted to form a handle, and the second end having an elongated slot extending along the side of the member. The slot extends from the second end to a first point towards the handle and the slot has a bottom. The bottom of the slot has an elongated aperture positioned between the second end and the first point. The aperture is dimensioned and configured to permit one of the bifurcated ends of the wrench to pass through the aperture.

### FIELD OF THE INVENTION

The invention relates generally to extension handles for increasing the leverage of wrenchs.

### BACKGROUND OF THE INVENTION

Double ended fixed jaw wrenches are common in any tool box or tool kit. These double ended wrenches are generally supplied in sets with different size wrenches for different size nuts. In order to increase the leverage on open ended wrenches, users have generally applied an extension handle to the wrench, thereby effectively increasing the length of the wrench. Over the years a variety of wrench extension handles have been developed. For example, U.S. Pat. No. 1,371,533 to Wright discloses a extension handle having an aperture in one end which is dimensioned to receive one of the jaws of the wrench. Similarly, U.S. Pat. No. 3,769,863 to Griffin discloses a wrench extender having an elongated handle portion and a wrench engaging socket which is dimensioned to receive one of the jaws of the double ended wrench. These wrench extenders, while effective in increasing the torsional forces which can be applied to the wrench, suffer from several drawbacks. Firstly, each of these designs tend to be fairly expensive to construct. Secondly, these wrench extenders do not secure the wrench as firmly as possible, leaving the possibility that the wrench may accidently dislodge from the extension when force is applied.

Several wrench extensions have been proposed which more securely bold the wrench in the wrench extension. These wrench extenders often have cross bars, adjustable clamps, linkages, and other structures which considerably increase the complexity and cost of these devices. A simple and cost effective wrench extension which securely holds wrenches has been unavailable.

### SUMMARY OF THE INVENTION

In accordance with the present invention, a improved extension handle for wrenches is provided. The extension handle includes an elongated member having a side, a length and opposite first and second ends, the first end being adapted to form a handle, and the second end having an elongated slot extending along the side of the member. The slot extends from the second end to a first point towards the handle. The slot has a bottom, and the bottom of the slot has an elongated aperture positioned between the second end and the first point. The aperture is dimensioned and configured to permit one of the bifurcated ends of the wrench to pass through the aperture.

With the foregoing in view, and other advantages as will become apparent to those skilled in the art to which this invention relates as this specification proceeds, the invention is herein described by reference to the accompanying drawings forming a part hereof, which includes a description of the preferred typical embodiment of the principles of the present invention, in which:

### DESCRIPTION OF THE DRAWINGS

FIG. 1, is a top view of the invention.

FIG. 2, is a cross sectional view of the invention.

FIG. 3, is a cross sectional view taken substantially along line A-A of FIG. 1, showing the interior configuration of this invention.

FIG. 4, is a cross sectional view of the alternate embodiment of the present invention.

FIG. 5, is a cross sectional view showing a typically wrench carried in the aperture of the invention.

FIG. 6, is a cross sectional view of another embodiment of the present invention.

FIG. 7, is a cross sectional view of another embodiment of the present invention, showing a typical wrench retained therein.

In the drawings like characters of reference indicate corresponding parts in the different figures.

### DETAILED DESCRIPTION OF THE INVENTION

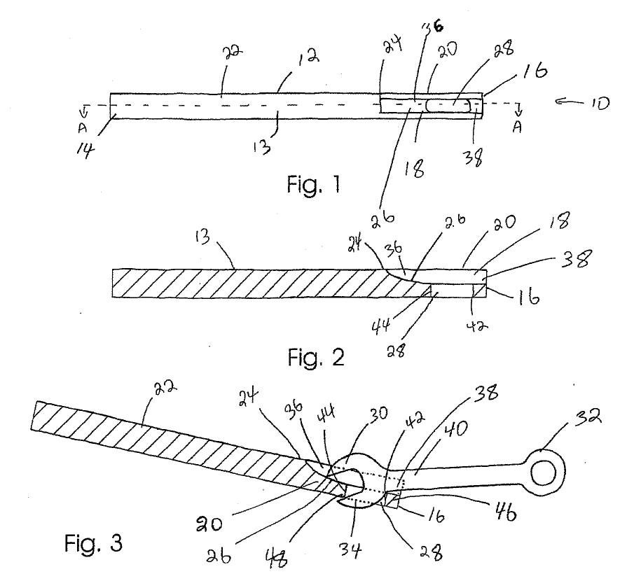

Referring firstly to FIGS. 1, 2, and 3, the extension handle of the present invention, shown generally as item 10 consists of an elongated member 12 having a side 13, an elongated axis indicated by line A-A, first end 14 and second end 16. Wrench engaging portion 20 is provided on member 12 adjacent end 16, and handle portion 22 is formed on member 12 adjacent end 14. Handle portion 22 is dimensioned and configured such that a user can comfortably and firmly grasp on to the handle. Wrench engaging portion 20 has an elongated grove 18 which extends from end 16 to point 24, which is positioned towards handle 22. Elongated grove 18 has a bottom 26 which is provided with an elongated aperture 28. Slot 18 is dimensioned such that jaw 30 of wrench 32 can be received in the grove. Aperture 28 is dimensioned to permit jaw 34 of wrench 32 to pass through the aperture.

Grove 18 has a first portion 36 which is positioned between aperture 28 and point 24. First portion 36 of grove 18 is sufficiently wide to permit either jaws 34 or 30 of wrench 32 to be retained therein. Grove 18 also has second portion 38 which extends between end 16 and aperture 28. Second portion 38 sufficiently wide to permit shank 40 of wrench 32 to be retained in the second portion.

The length of aperture 28 is limited by walls 42 and 44 which are formed on wrench engaging portion 20. The length of aperture 28 is selected such that only one of jaws 30 or 34 can pass through the aperture at one time. This permits wrench extension 10 to trap jaw 34 between terminal portion 46 of end 16 and portion 48 of wrench engaging portion 20. With jaw 34 positioned as shown in FIG. 3, the user may apply considerably torque on to wrench 32 by pressing down on handle portion 22. First portion 36 of slot 18 secures jaw 30 within wrench engaging end 20, and second portion 38 of the slot 18 secures shank 40, thereby preventing the wrench from accidently dislodging. Since jaw 30 is retained within first portion 36 of grove 18, wrench 30 is more securely held within wrench engaging portion 20. This allow the user to apply more torque to wrench 30 without fear of the wrench accidently being dislodged.

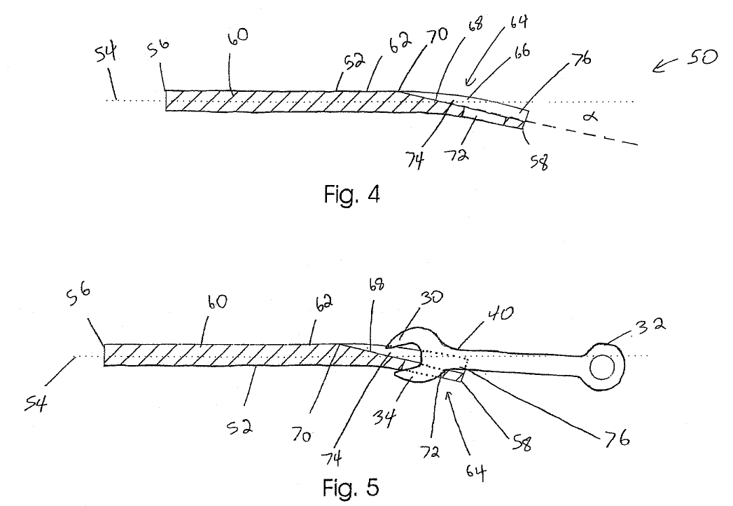

Referring now to FIGS. 4 and 5, an alternate embodiment of the present invention as shown in item 50, and consists of an elongated member 52 having axis 54, first end 56, second end 58, and side 62. Handle portion 60 is formed towards first end 56 while wrench engaging portion 64 is formed towards second end 58. Wrench engaging portion 64 has an elongated grove 66 which commences at second end 58 and progresses to point 70 which is positioned adjacent handle portion 60. Grove 66 has bottom 68 which is provided with aperture 72 located between end 58 and point 70. Grove 66 is divided into two portions, namely; first portion 74, which extends between aperture 72 and point 70 and second grove portion 76, which extends from aperture 72 to end 58.

Grove 66 is dimensioned to receive jaws 30 and 34 of wrench 32. Aperture 72 is dimensioned to permit jaw 30 or 34 of wrench 32 to pass through the aperture. First grove portion 74 is sufficiently wide to permit jaw 30 to be retained in the grove portion, while grove portion 76 is sufficiently wide to permit shank portion 40 of wrench 32 to be retained within the second grove portion. As best seen in FIG. 5, when jaw 34 is inserted into aperture 72, jaw 30 is retained within grove portion 74 while shank 40 is retained within grove portion 76 thereby securing the wrench within wrench engaging portion 64.

Wrench engaging portion 64, is at an acute angle from axis 54. It has been discovered that if angle α is approximately 15°, then wrench 32 will be positioned approximately in line with axis 54 when the wrench is inserted into wrench engaging portion 64. With the wrench extension 50 and wrench 32 being joined together in substantially coaxial alignment, it is easier for a user to apply torsional forces on to wrench 32.

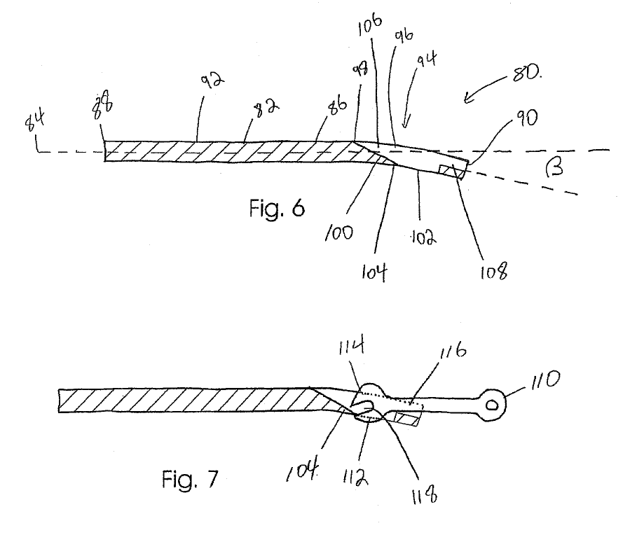

Referring now to FIGS. 6 and 7, a third embodiment of the present invention is shown generally as item 80. Wrench extension 80 consists of an elongated member 82 having elongated axis 84, side 86, first end 88, and opposite second end 90. Handle portion 92 is formed on member 82 towards end 88. Wrench engaging portion 94 is formed on member 82 adjacent end 90. Preferably wrench extension 94 is positioned at an acute angle β relative to axis 84. Preferably angle β is approximately 15′.

Wrench engaging portion 94 is provide with an elongated grove 96 which extends from end 90 to point 98 adjacent 92. Grove 96 is provided with bottom 100, which is in turn provided with aperture 102. Aperture 102 is positioned between end and point 98 such that a first portion 106 of grove 96 extends between the aperture and point 98, and a second portion 108 extends between aperture 102 and end 90. As in the previous embodiments, aperture 102 is dimensioned to permit jaw 112 of wrench 110 to pass through the aperture. Also as in the previous embodiments, first portion 106 of grove 96 is sufficiently wide to receive jaw 114 of wrench 110 and second portion 108 of the grove is dimensioned to permit shank 116 to be retained within the second portion. Portion 104 of bottom 100 which is adjacent aperture 102 is wedge shaped. As best seen in FIG. 7, the wedge shape of portion 104 permits the device to be used with small wrenches. For example, wrench 110 has open ended jaws 112 and 114 spaced fairly close together in order to accommodate a very small nut. Therefore, gap 118 between jaws 112 and 114 is quite narrow. The wedge shape of portion 104 permits the wedge portion to be inserted into gap 118 permitting the wrench extension to be used with very small wrenches.

Referring back to FIG. 3, elongated grove 18 not only helps stabilize wrench 32 but also aids in attaching wrench jaws 30 and 34 to wrench engaging portion 20. First grove section 36 acts as a guide permitting jaw 34 to be more easily positioned within wrench engaging section 20. The user first inserts jaw 34 into grove 36 and then slides the wrench along bottom 26 until aperture 28 is reached. Hence, by extending grove 18 beyond aperture 28 and towards handle portion 22, a more effective wrench extension is created.

A specific embodiment of the present invention has been disclosed; however, several variations of the disclosed embodiment could be envisioned as within the scope of this invention. It is to be understood that the present invention is not limited to the embodiments described above, but encompasses any and all embodiments within the scope of the following claims.

Therefore, what is claimed is:

1. An extension handle for increasing the leverage of a wrench having a shank with a bifurcated end, said extension handle comprising:
an elongated member having a side, a length and opposite first and second ends;
the first end adapted to form a handle;
an elongated slot extending along the side of the member, said slot extending from the second end to a first point towards the handle, said slot having a bottom, and
an elongated aperture extending through the bottom of the slot, said aperture positioned between the second end and the first point, said aperture dimensioned and configured to permit one of the bifurcated ends of the wrench to pass there through.

2. The extension handle defined in claim 1 wherein a first portion of the slot extending between the handle and the aperture is dimensioned and configured to receive one of the bifurcated ends of the wrench.

3. The extension handle defined in claim 1 wherein a second portion of the slot extending between the second end and the aperture is dimensioned and configured to receive the shank of the wrench.

4. The extension handle defined in claim 2 wherein a second portion of the slot extending between the second end and the aperture is dimensioned and configured to receive the shank of the wrench.

5. An extension handle for increasing the leverage of a wrench having a shank with a bifurcated end, said extension handle comprising:
an elongated member having a side, a length and opposite first and second ends;
the first end adapted to form a handle, said handle having a longitudinal axis;
a distal portion adjacent the second end, said distal portion extending at an acute angle from the handle,
the distal portion having an elongated slot extending along the side, said slot extending from the second end to a first point adjacent the handle, said slot having a bottom, and
an elongated aperture extending through the bottom of the slot, said aperture positioned between the second end and the first point, said aperture dimensioned and configured to permit one of the bifurcated ends of the wrench to pass there through.

6. The extension handle defined in claim 5 wherein a first portion of the slot extending between the handle and the aperture is dimensioned and configured to receive one of the bifurcated ends of the wrench.

7. The extension handle defined in claim 5 wherein a second portion of the slot extending between the second end and the aperture is dimensioned and configured to receive the shank of the wrench.

8. The extension handle defined in claim 6 wherein a second portion of the slot extending between the second end and the aperture is dimensioned and configured to receive the shank of the wrench.

9. The extension handle defined in claim 8 wherein a wedge portion is formed on the bottom adjacent the aperture.

10. The extension handle defined in claim 9 wherein the wedge portion is positioned in the first portion of the slot.

11. The extension handle defined in claim 6 wherein a wedge portion is formed on the bottom adjacent the aperture.

12. The extension handle defined in claim 11 wherein the wedge portion is positioned in the first portion of the slot.
